(19) United States
(12) Patent Application Publication
(10) Pub. No.: US 2008/0228656 A1
(43) Pub. Date: Sep. 18, 2008

(54) Method for implementing an enhanced auction via a communications network

(76) Inventor: Bhavik P. Soni, Tallahassee, FL (US)

Correspondence Address: J. WILEY HORTON, ESQUIRE;Pennington, Moore, Wilkinson, Bell & Dunbar, P.A., Post Office Box 10095, 215 S. Monroe Street, Tallahassee, FL, 32302-2095, US

(21) Appl. No.: 11/716,820

(22) Filed: Mar. 12, 2007

(51) Int. Cl. G06Q 30/00

(52) U.S. Cl. 705/80

(57) ABSTRACT

A method of selectively implementing a live auction option in a conventional timed electronic auction. The host-server monitors bidding activity in a timed auction to detect an indication of competitive bidding. If competitive bidding is detected, a “live auction” is triggered. The client-users are provided information regarding how to participate in the live auction, which may be held immediately or at a set time in the future. Preferably, only those users who submitted a bid during the final stages of the timed auction will be allowed to participate. The live auction is not conducted by a human auctioneer. Rather, it is conducted by a software-implemented process. However, all bidders are given warnings when the auction is about to close and sufficient time to submit additional bids. These warnings can mimic a human auctioneer, such as web-posted “going once,” “going twice” calls.

### BACKGROUND OF THE INVENTION

1. Field of the Invention

This invention relates to the field of on-line product sales. More specifically, the invention comprises a method for conducting a live auction in the event that several prospective purchasers are contesting a purchase during a conventional timed auction.

2. Description of the Related Art

Product sales are now routinely conducted over the worldwide electronic communication network known as the Internet. The products are presented in many ways and the sales are conducted under various formats. One particularly popular format is known as the “electronic auction.” In this format, an item for sale is displayed and geographically remote computer users submit “bids” in electronic form. There are many websites currently using this format, with the site owned by eBay, Inc., of San Jose, Calif. being the most popular.

The company hosting the electronic auction loads information on a computer “server.” Remote “client” users typically create an account on this server. The client-users are thereby registered to take place in one or more auctions. The registration would include pertinent information such as the client-user's name, email address, and physical address. When an auction is conducted, the remote client-users electronically submit bids to the hosting server. A website display is provided by the hosting server so that the client-users can view details regarding the auction. The users can also observe updated information regarding the bidding.

Those skilled in the art will know that data must be transmitted back and forth between the host-server computer and the client-user computer. Data from the host-server will cause an appropriate web page display to appear on the client-user's computer monitor. Data transmitted from the client-user may likewise cause updates to be displayed on the web page shown to all users. This exchange of data and presentation of displays on computer monitors are well known in the art. The actual processing of data and presentation of the user interface will therefore not be described in any detail. However, the user should bear in mind that the graphical depictions used to explain the current invention are to be understood as representing computer “web page” type displays. Many different formats could be used for such displays and the invention is certainly not confined to any one format.

Electronic auctions have traditionally not followed the format of a live auction. Since hundreds of thousands of items are often up for sale on a given auction website, it is impractical to have a live “auctioneer” conducting each auction. Thus, the bidding process is not called to a close by a third party. Instead, the running of a time limit is frequently used to limit the process.

A simple example illustrates this approach: FIG. 1 shows a representative display presented to a client-user in an electronic auction. Product information display 10 describes the item to be sold. It typically contains image 12, with accompanying text 14.

Bid data display 16 shows information the client-user needs to participate in the auction. Current bid display 18 shows the current maximum bid that has been entered for the item. Bid increment display 20 shows the amount of incremental bid that has been established (if such a limit is present).

Auction time limit display 22 shows the exact time when the auction will close. Remaining time display 24 displays the remaining time, which is updated continuously so that each client-user knows how much time remains.

Bid button 26 allows a client-user to enter a bid. It is not a physical button, of course, but rather an electronic display which a user can actuate by clicking with a pointing device such as a computer mouse. If the user does activate the bid button, then he or she will be prompted to enter an amount in bid entry box 28.

In this specific example, the current bid is $415. The minimum bid increment is $5. If the user wishes to enter a bid, he or she will activate bid button 26 and then type in a bid of $420 or more.

The example shown in FIG. 1 is simplistic. Those skilled in the art will know that the dialogue boxes shown in the figure might be displayed on two or more pages with the user being prompted to select additional “layered” windows. Other features are also typically present. A user is sometimes allowed to “proxy bid.” In this scenario, the user submits the maximum amount he or she is willing to pay. This amount may exceed the current bid. Software running on the host-server will then increase the proxy bid user's bid as necessary, up to the maximum amount.

As an example, with the current bid at $300 and a minimum bid increment of $5, a proxy bidder might decide that she is willing to pay up to $500 for the item. The user is given the chance to enter that $500 maximum. Software on the host-server would then enter a proxy bid for the user at $305. The software would update the proxy bidder's bid as necessary to top other bids received, up to the maximum of $500. This feature “optimizes” the purchase for the proxy bidder, since she does not need to continually monitor the bidding. If no further bids are received after her proxy bid of $405, then she will “win” the item for that amount. If the bid is raised beyond $500, then no more proxy bids will be entered on her behalf.

A timed auction will continue until the time runs out. The highest bidder recorded in the system at the instant that time expires will be the winning bidder. Such a system is easily automated. It also provides a clear criterion for selecting the winning bidder. Unfortunately, however, the use of a time deadline can produce unwanted behavior.

The central idea of an electronic auction is that a client-user opens the web page, views the item, and then submits a bid stating what he or she is willing to pay for the item displayed. In the case of a proxy bid, the client-user is able to establish a maximum amount he or she is willing to pay, even though that amount may be substantially greater than the current bid. A well-reasoned bid is the goal, since this produces a sale which is near the item's fair market value.

The presence of the time deadline often alters this behavior. Rather than submitting a well-reasoned bid, many users will monitor the auction and wait for the last possible moment to bid. If the price is still considered low, a flurry of users will raise the bid in small increments during the last moment or two of the auction. Victory in the bidding is often a matter of random chance, as many electronic bids will bombard the host-server during the last few seconds. The winner is simply the last bid to come in before the instant the auction expires.

Often the losing bidders would have been willing to pay more for the item. They were simply unable to put their bids through before time expired. Those skilled in the art will realize that the dynamics of this arrangement are fundamentally different from those of a live auction.

A live auction promotes competitive engagement between bidders. This engagement often yields higher sale prices. It also gives every prospective buyer a fair chance at the item for sale. No purchaser misses a purchase because of timing. Rather, he or she has made a conscious decision that the current price has gone beyond what he or she is willing to pay.

Internet-based auction companies do provide live auctions on certain occasions. However, the live auction feature is not combined with the existing timed auctions. The present invention seeks to remedy the perceived shortcomings of timed auctions by implementing a selective live auction feature.

### BRIEF SUMMARY OF THE PRESENT INVENTION

The present invention comprises a method of selectively implementing a live auction option in a conventional timed electronic auction. The host-server monitors bidding activity in a timed auction to detect an indication of competitive bidding. If competitive bidding is detected, a “live auction” is triggered. The client-users are provided information regarding how to participate in the live auction, which may be held immediately or at a set time in the future. Preferably, only those users who submitted a bid during the timed auction will be allowed to participate.

The live auction is not conducted by a human auctioneer. Rather, it is conducted by a software-implemented process. However, all bidders are given warnings when the auction is about to close and sufficient time to submit additional bids. These warnings can mimic a human auctioneer, such as web-posted “going once,” “going twice” calls.

### BRIEF DESCRIPTION OF THE SEVERAL VIEWS OF THE DRAWINGS

FIG. 1 illustrates a representative screen display used in a timed electronic auction.

FIG. 2 illustrates a representative screen display used to implement a live auction option.

FIG. 3 shows a representative notice of closing a timed electronic auction.

FIG. 4 shows a screen display used to submit bids in a live electronic auction.

FIG. 5 shows a representative information display screen.

FIG. 6 shows the display of FIG. 4 altered to indicate that the live auction is underway.

FIG. 7 shows the first warning display in a live auction.

FIG. 8 shows the second warning display in a live auction

FIG. 9 shows the final warning display in a live auction.

FIG. 10 shows a “sold” display in a live auction.

FIG. 11 shows a representative screen display allowing a prospective purchaser to select a live auction option.

### REFERENCE NUMERALS IN THE DRAWINGS

| | | | |
|---|---|---|---|
| 10 | product information display | 12 | image |
| 14 | text | 16 | bid data display |
| 18 | current bid display | 20 | bid increment display |
| 22 | auction time limit display | 24 | remaining time display |
| 26 | bid button | 28 | bid entry box |
| 30 | live auction status indicator | 32 | information button |
| 34 | live auction announcement | 36 | time-to-start display |
| 38 | information button | 40 | live auction log-in button |
| 42 | confirmation message | 44 | live auction number |
| 46 | commencement announcement | | |
| 48 | first winning display | 50 | gavel depiction |
| 51 | second warning display | 52 | final warning display |
| 54 | sold message | 56 | item description input |
| 58 | image submission button | 60 | live auction option |

### DETAILED DESCRIPTION OF THE INVENTION

The drawing figures accompanying this explanation show representative web pages implementing the invention. Those skilled in the art will realize that the method claimed herein could be graphically depicted in many different ways. Thus, the drawings should be viewed as only one embodiment among many possible embodiments.

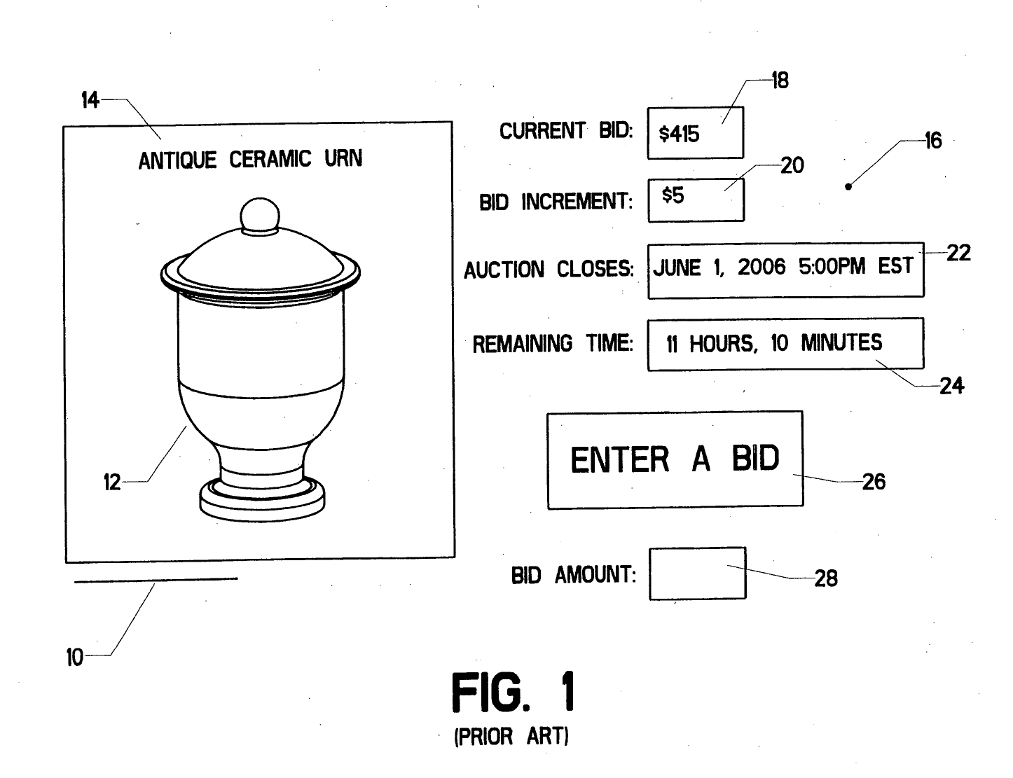

Returning to FIG. 1, the reader will recall the preceding example of a prior art timed auction. The time period on this auction closes at 5:00 P.M. EST, on Jun. 1, 2006. The first step in implementing the proposed invention is determining whether a competitive bidding environment exists. Automation is preferable, so the criteria for establishing the existence of competitive bidding should be objective.

As one example, the existence of competitive bidding could be tested by the presence of at least three bid submissions during the last ten minutes of the time period. Software running on the host server can test this condition. If three bid submissions are detected, then a competitive bidding environment is found to exist. An electronic “live auction” will then be held.

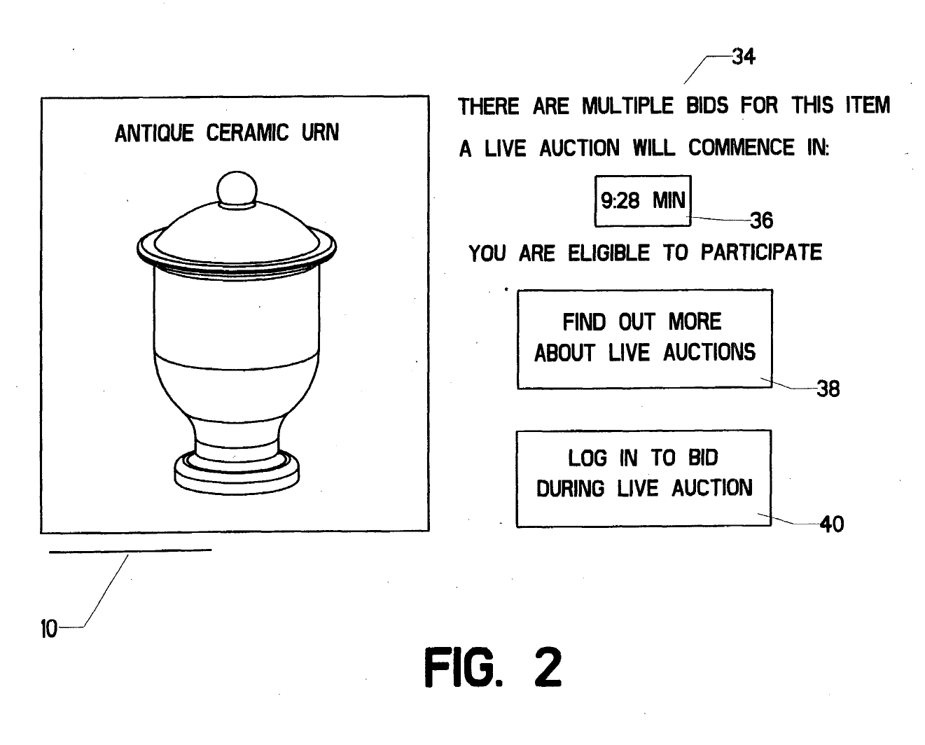

Rather than closing the auction and awarding the item to the last bid submitted prior to expiration, an electronic notification is sent to all the users who submitted a bid during the timed auction. This notification could appear on the client-user's computer screen as the depiction shown in FIG. 2. The product information display remains. Live auction announcement 34 informs this particular user that he or she is eligible to participate. Time-to-start display 36 counts down the time to when the live auction will commence.

It is possible to start the live auction immediately. However, as some users may be unfamiliar with the live auction process, it may be desirable to provide a delay. The delay could be brief (such as 10 minutes) or lengthy (such as one day). This delay allows the user to study the rules of the live auction. It may also allow the experienced user to pause and consider how much he or she would actually be willing to pay in a competitive bidding environment.

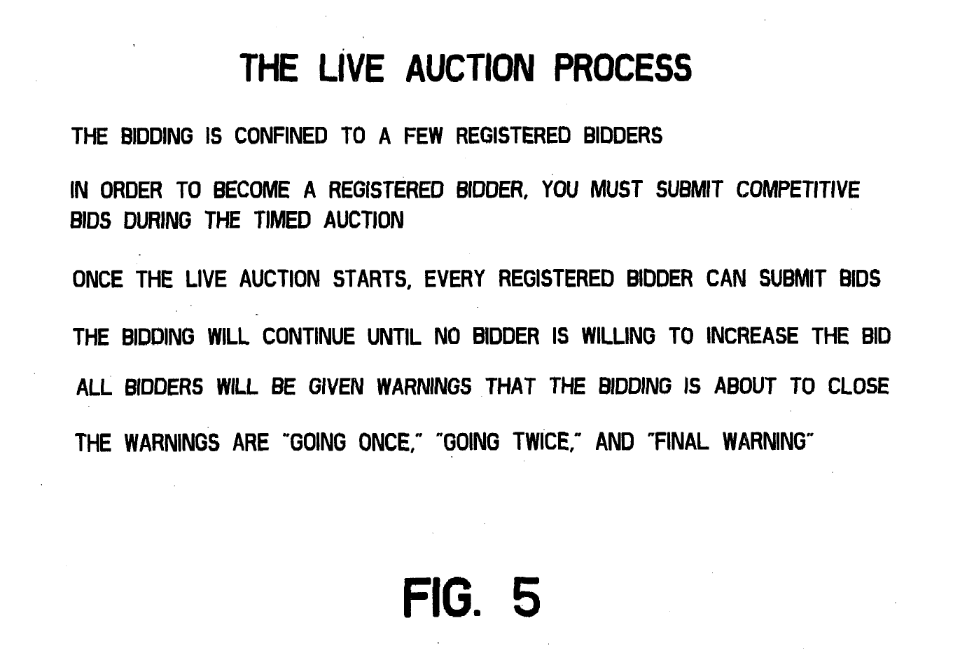

Information button 38 is provided for users who are not familiar with the live auction process. If this “button” is selected, then a separate page listing the live auction rules is displayed. FIG. 5 shows a depiction of such a page.

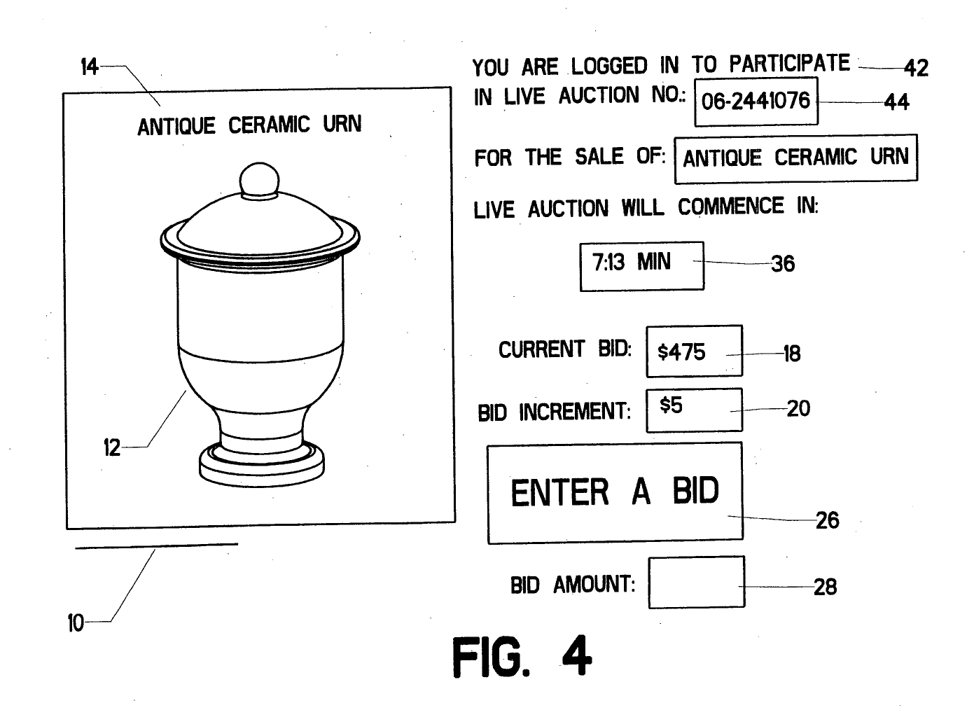

Returning now to FIG. 2, live auction log in button 40 is provided. The user selects this button if he or she wants to participate. This action causes the client-user's computer to transmit a participation signal to the host-server. Once received, the host-server confirms that this particular client-user did indeed place a bid during the timed auction (assuming that is the criterion established for selection). Assuming this is confirmed, the host-server transmits information to the client-user's computer causing a display such as shown in FIG. 4 to appear.

Confirmation message 42 confirms that the client-user is logged in and ready to participate. Live auction number 44 can be displayed to numerically identify which auction is about to be conducted. Product information display 10 is preferably included so that the client-user can easily verify that he or she is about to bid on the correct item. Time-to-start display 36 appears and continues to count the time down. Current bid display 18 and bid increment 20 are shown. Bid button 26 and bid entry box 28 are provided, as for the conventional timed portion of the auction.

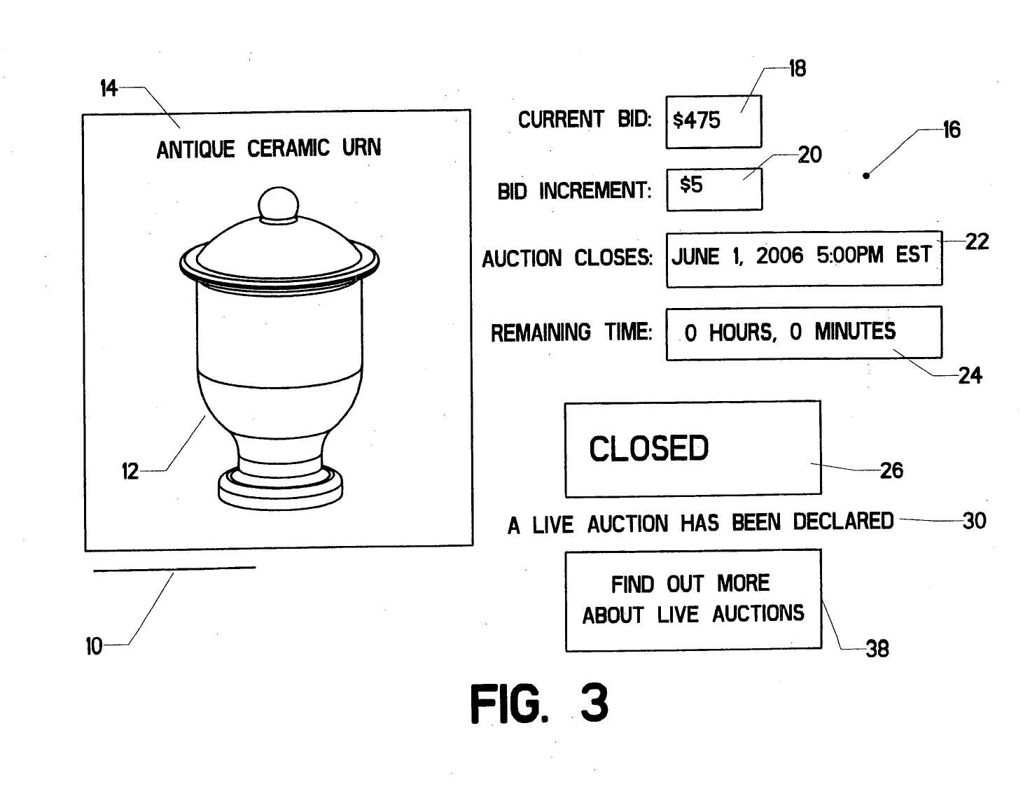

The reader may wonder what is displayed to those users who did not submit a bid during the timed bidding period. In order to promote interest in the live auction feature, it may be advantageous to provide some information to non-participating client-users. At the close of the time period on the conventional timed auction, the display can be changed to one like that shown in FIG. 3. Bid button 26 changes to display a “CLOSED” message. Live auction status indicator 30 declares that a live auction will be conducted. Since many users may be unfamiliar with the live auction feature, information button 38 is provided. If the client-user selects this button, a new page will be displayed providing information on live auctions. The user will thereby learn that in order to participate (in this particular example), he or she must take part in the bidding during the conventional timed period.

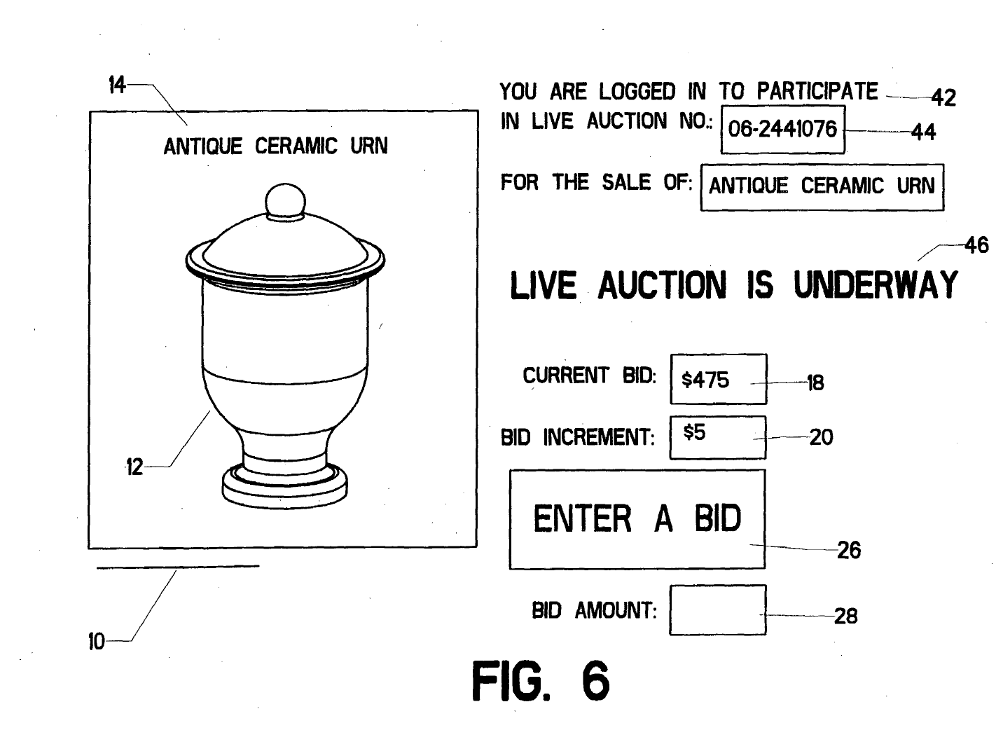

Returning now to those users who are eligible to participate, the reader will recall that a user who has elected to participate in the live auction will see a display such as the one shown in FIG. 4. Time-to-start display 36 will count down to zero. At that point, the display preferably changes to indicate that the live auction is underway. FIG. 6 shows how this modification might look, with commencement announcement 46 replacing the time-to-start display.

The live auction then proceeds, with each participating client user submitting bids as he or she chooses. The live auction commences with the highest bid received in the timed auction. In other words, the bidding can only go up. It is also possible to carry over a maximum proxy bid entered by the winning bidder in the timed auction (since the timed auction may have been “won” at a level below that bidder's maximum bid).

Current bid display 18 will update to reflect each newly submitted bid. The live auction will not close until the current bid remains static for a fixed period. Warnings of imminent closure will also be given. These are preferably given in a format known to those who attend in-person auctions.

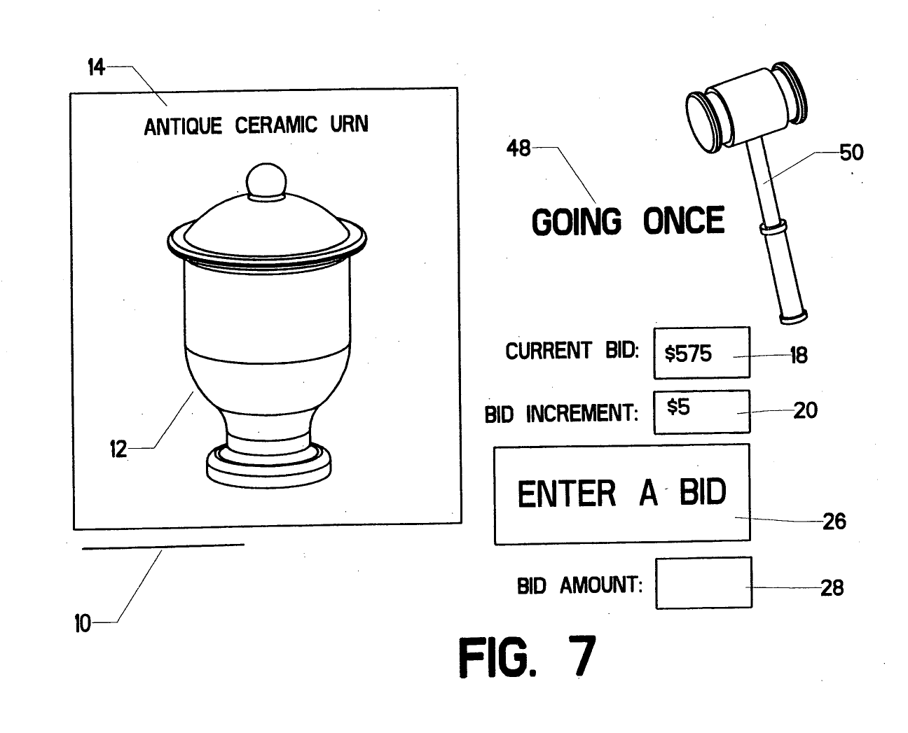

As one example, the threshold for closure might be receiving no bid increase for 60 seconds. At that time, the host-server can update the display on each client-user's computer to look something like FIG. 7. First warning display 48 warns the user that the bidding is about to close. Current bid display 18, bid button 26, and bid entry box 28 remain. A visual cue is preferably added, such as gavel depiction 50.

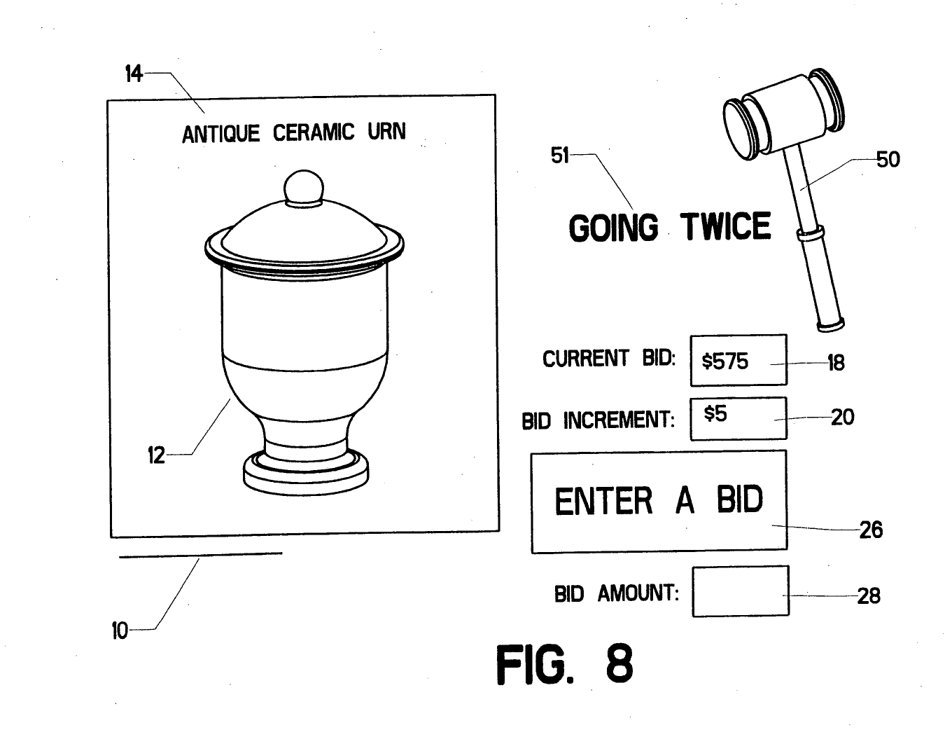

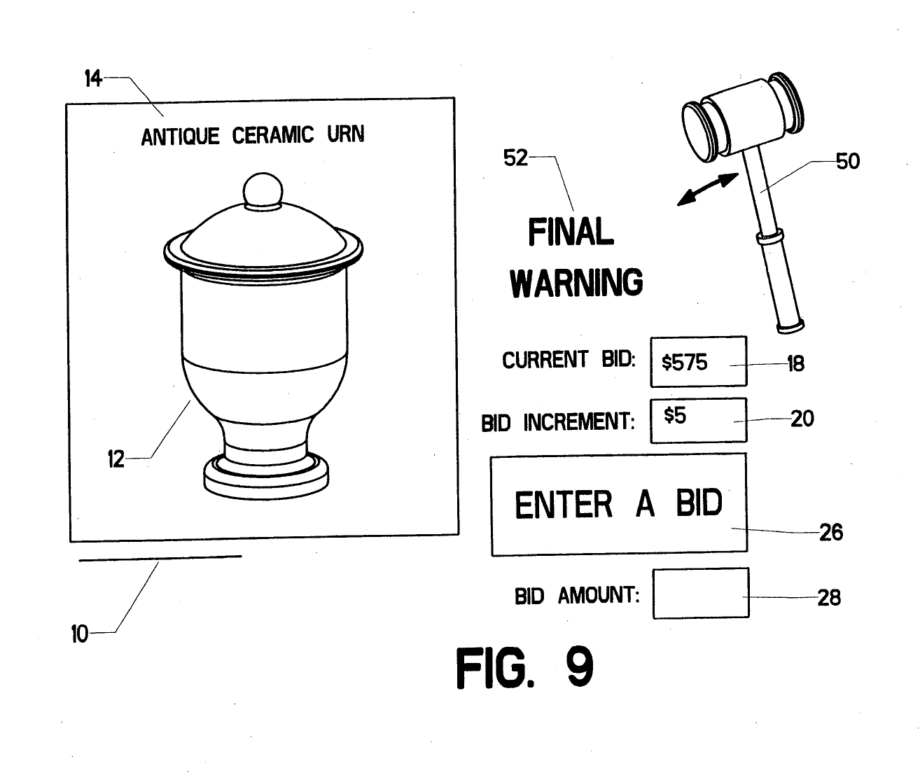

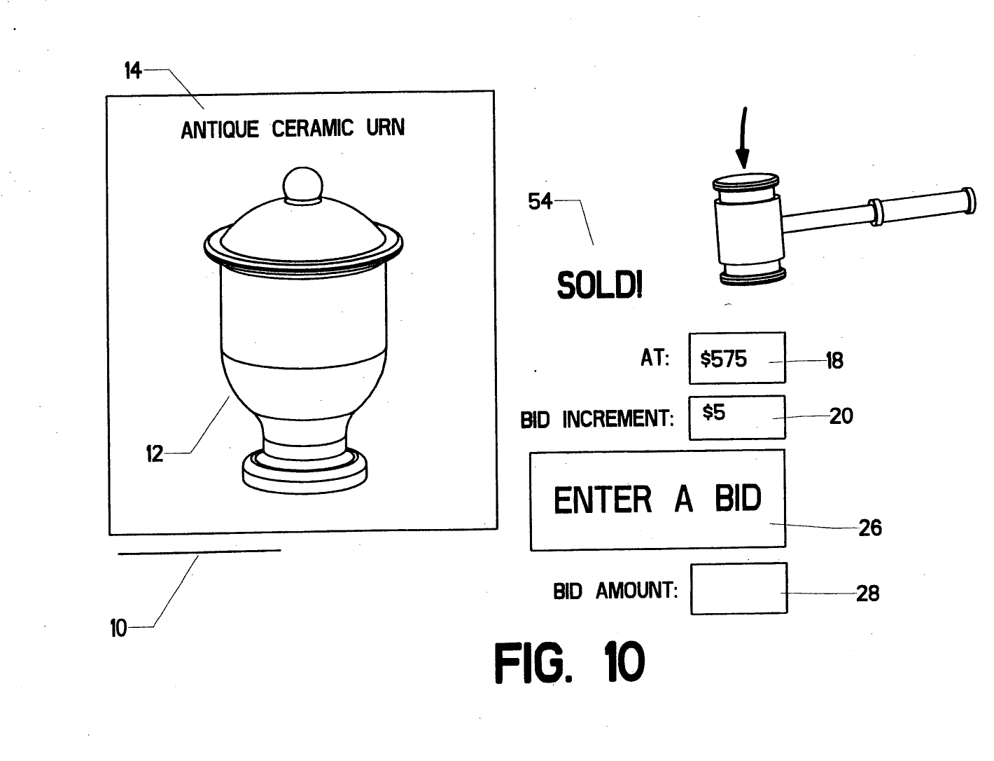

If a bid is received at that point, then the display reverts to that shown in FIG. 6 and bidding proceeds. If, however, no additional bid is received for a fixed time period, the display changes to something like FIG. 8, where second warning display 51 replaces first warning display 48. Again, if a new bid is submitted, the display reverts to that of FIG. 6. If, however, no bid is received for a fixed time period, then the display progresses to something like that shown in FIG. 9. Final warning display 52 is shown. Additional visual cues are preferably added, such as having gavel depiction 50 swing about as though ready to descend. At any time if a bid is received, normal bidding under the depiction shown in FIG. 6 resumes (which starts a new “GOING ONCE,” “GOING TWICE,” “FINAL WARNING” cycle). However, assuming no response is received to the final warning of FIG. 9, then the display proceeds to something like FIG. 10. Sold message 54 is displayed. Gavel depiction 50 preferably swings downward to graphically depict the sale of the item.

This example serves to illustrate how the electronic live auction can mimic the dynamics of in-person auctions. Each participant knows he or she is competitively bidding against a limited number of other participants. There is no time limit, so the auction will continue until no participant is willing to raise the bid. The live auction does not commence until a starting price has been established by the close of the conventional timed auction. Thus, the bidding can only go up. Sellers benefit from possibly receiving a higher price. Sellers also benefit from the fact that buyers are more likely to submit a well-reasoned maximum bid, as opposed to waiting until the last minute to try to time the close of the auction. The prospective purchasers benefit since each is given a fair chance to bid without the arbitrary threat of time closure. The business running the host-server also benefits, since its service fee is typically a percentage of the sale price.

The implementation of the live auction option may in fact alter the unwanted behavior during the timed auction. Once most users become aware that the live auction option exists, the overall behavior during the conventional timed auction is likely to become more reasonable.

The steps comprising the live auction can be generally described as:

1. Conducting a conventional timed auction with a fixed expiration point;

2. Monitoring for the presence of competitive bidding during a time period preceding the fixed expiration point (with it being understood that the time period could be any portion or all of the entire time the timed auction is open);

3. If competitive bidding is detected then, upon the closure of the timed auction, providing those submitting bids within the timed auction period an opportunity to participate in a live auction at a specified time; and

4. Conducting a live auction with no set time period in which all bidders are given fair warning of imminent closure and only the failure of any participant to raise the bid results in the closure of the auction.

The preceding explanation has presented the invention from the perspective of a client-user who logs onto the auction website as a prospective customer. Of course, many client-users will log onto the website as a prospective seller. The reader may therefore wish to know how the invention might appear to those users.

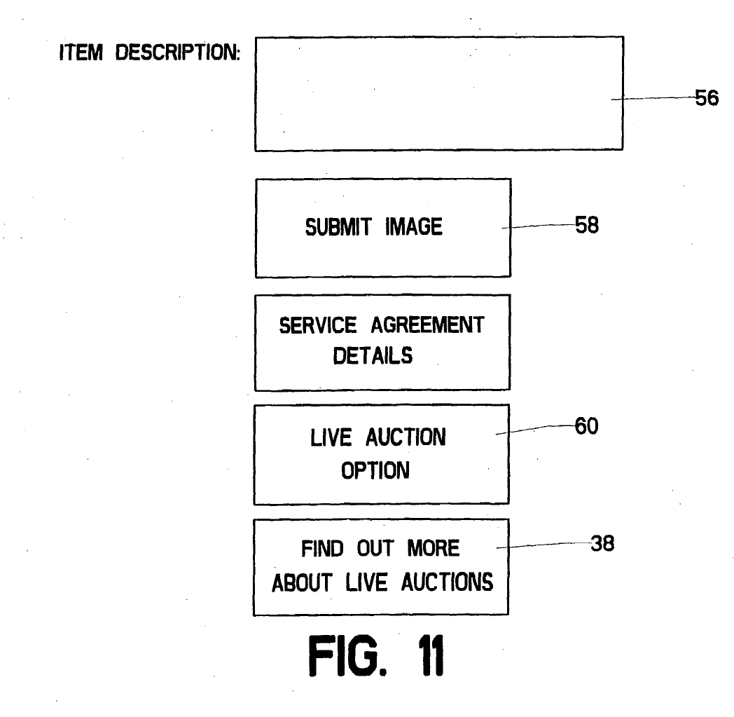

A client-user wishing to place an item up for billing logs into the host-server and typically fills out information required to register (such as the client-user's name, address, email address, method of payment, etc.). The client-user may then be shown a display such as shown in FIG. 11.

Item description input 56 allows the user to type in a textual description, such as “Antique Ceramic Urn.” Image submission button 58 allows the user to attach an image file of the item to be sold (such as a JPEG or TIFF formatted file). At some location in the display the user will be given live auction option 60. If the user selects this option, he or she will be given information about the live auction process, along with terms and conditions for implementing it.

As an example, the host-server company might charge a one time fee of $5 to enable the live auction option for a particular buyer. Information button 38 is preferably provided to inform the novice user of the advantages of a live auction. It will open a page describing how the live auction works. In this page it will inform the user that the live auction can only increase the sale price. The “worst case” for the seller is that the live auction produces no increase in the bid price. Because of the likelihood of escalating the bid, some host-server companies may elect not to charge for the live auction at all. They would recoup any operational costs from the increased commission received on the increased average sale price.

Of course, the live auction option could be made available to the purchasers as well. A message could be displayed during the conventional timed auction stating that a live auction option is available for purchase. Any of the prospective purchasers could then pay a fixed charge to enable the live auction feature at the termination of the timed auction.

Other options are possible in implementing the present invention. These include, without limitation:

1. Monitoring for the presence of competitive bidding only near the end of the timed auction period, such as by counting whether the number of bids exceed a fixed threshold within this period;

2. Monitoring for the presence of competitive bidding by monitoring the time interval between successive bids and declaring the bidding to be competitive if the time interval drops below a fixed threshold;

3. Implementing the live auction substantially later than the closed timed auction (such as a full day later), in order to allow all parties to schedule the time and fully participate;

4. Allowing an option where the prospective purchasers opt for the live auction and each purchaser wishing to participate must pay a share of the live auction fee;

5. Providing a live auction notice only to persons bidding in a competitive environment near the close of the conventional timed auction period;

6. Allowing any person to pay a fee in order to join the live auction, whether they participated in the timed auction or not;

7. Allowing proxy bidding in the live auction, so that those participants who were unable to remain for the live auction could confidentially submit a maximum bid to the host-server, which would then incrementally bid up to the maximum;

8. Allowing the seller to pay a fee in order to trigger a live auction at any time; and

9. Using different criteria for eligibility in the live auction, such as whether a client-user submitted a bid during the timed auction which was within a fixed amount of the highest bid or a fixed percentage of the highest bid.

Although the preceding description contains significant detail, it should not be construed as limiting the scope of the invention but rather as providing illustrations of the preferred embodiments of the invention. The inventive process could be carried out in many different ways. Thus, the scope of the invention should be fixed by the following claims rather than the examples given.

Having described my invention, I claim:

1. A method of placing bids for an item in an electronic auction, said electronic auction being hosted by a host-server which is connected over an electronic communication network to a plurality of client-users, comprising:
a. conducting a timed auction, wherein said client-users submit bids to said host-server over said electronic communication network;
b. monitoring for competitive bidding during said timed auction;
c. if competitive bidding is detected during said timed auction, establishing a live auction to be held after the conclusion of said timed auction;
d. establishing a set of criteria for participation in said live auction;
e. applying said set of criteria to said plurality of client-users in order to establish a set of live auction qualified client-users;
f. sending notice of said live auction to said set of live auction qualified client-users across said electronic communication network; and
g. at a preset time after the conclusion of said timed auction, conducting a live auction in which
i. each client-user in said set of live auction qualified client-users is allowed to submit bids to said host-server over said electronic communication network;
ii. said live auction continues until no increase in the bid price is received for a predetermined interval; and
iii. giving a warning to all participants in said live auction that said live auction is about to close and an opportunity to submit an additional bid.

2. A method of placing bids as recited in claim 1, wherein said set of criteria for participation in said live auction comprises determining whether a particular client-user submitted a bid during said timed auction.

3. A method of placing bids as recited in claim 1, wherein said set of criteria for participation in said live auction comprises determining whether a particular client-user submitted a bid which was within a fixed difference of the highest bid submitted during said timed auction.

4. A method of placing bids as recited in claim 1, wherein said set of criteria for participation in said live auction comprises determining whether a particular client-user submitted a bid which was within a fixed percentage of the highest bid submitted during said time auction.

5. A method of placing bids as recited in claim 1, wherein said set of criteria for participation in said live auction comprises determining whether a particular client-user submitted a bid near the end of said timed auction.

6. A method of placing bids as recited in claim 1, wherein each client-user in said set of live auction qualified client-users is allowed to submit a maximum proxy bid, whereupon said host-server will automatically submit bids up to said maximum proxy bid.

7. A method of placing bids as recited in claim 2, wherein each client-user in said set of live auction qualified client-users is allowed to submit a maximum proxy bid, whereupon said host-server will automatically submit bids up to said maximum proxy bid.

8. A method of placing bids as recited in claim 3, wherein each client-user in said set of live auction qualified client-users is allowed to submit a maximum proxy bid, whereupon said host-server will automatically submit bids up to said maximum proxy bid.

9. A method of placing bids as recited in claim 4, wherein each client-user in said set of live auction qualified client-users is allowed to submit a maximum proxy bid, whereupon said host-server will automatically submit bids up to said maximum proxy bid.

10. A method of placing bids as recited in claim 5, wherein each client-user in said set of live auction qualified client-users is allowed to submit a maximum proxy bid, whereupon said host-server will automatically submit bids up to said maximum proxy bid.

11. A method of placing bids as recited in claim 1, wherein said step of monitoring for competitive bidding comprises recording a time interval between successive bids received and declaring competitive bidding to exist if said time interval falls below a fixed threshold.

12. A method of placing bids as recited in claim 1, wherein said step of monitoring for competitive bidding comprises recording the total number of bids received within a fixed time period proximate the close of said timed auction and declaring competitive bidding to exist if said total number of bids received exceeds a fixed threshold.

13. A method of placing bids as recited in claim 1, wherein said step of monitoring for competitive bidding comprises recording the total number of bids received within the entire time period of said timed auction and declaring competitive bidding to exist if said total number of bids received exceeds a fixed threshold.

14. A method of placing bids as recited in claim 2, wherein said step of monitoring for competitive bidding comprises recording a time interval between successive bids received and declaring competitive bidding to exist if said time interval falls below a fixed threshold.

15. A method of placing bids as recited in claim 3, wherein said step of monitoring for competitive bidding comprises recording the total number of bids received within a fixed time period proximate the close of said timed auction and declaring competitive bidding to exist if said total number of bids received exceeds a fixed threshold.

16. A method of placing bids as recited in claim 4, wherein said step of monitoring for competitive bidding comprises recording the total number of bids received within the entire time period of said timed auction and declaring competitive bidding to exist if said total number of bids received exceeds a fixed threshold.

17. A method of placing bids as recited in claim 5, wherein said step of monitoring for competitive bidding comprises recording a time interval between successive bids received and declaring competitive bidding to exist if said time interval falls below a fixed threshold.

18. A method of placing bids as recited in claim 6, wherein said step of monitoring for competitive bidding comprises recording the total number of bids received within a fixed time period proximate the close of said timed auction and declaring competitive bidding to exist if said total number of bids received exceeds a fixed threshold.

19. A method of placing bids as recited in claim 7, wherein said step of monitoring for competitive bidding comprises recording the total number of bids received within the entire time period of said timed auction and declaring competitive bidding to exist if said total number of bids received exceeds a fixed threshold.

20. A method of placing bids as recited in claim 8, wherein said step of monitoring for competitive bidding comprises recording a time interval between successive bids received and declaring competitive bidding to exist if said time interval falls below a fixed threshold.
